(19) United States
(12) Patent Application Publication
(10) Pub. No.: US 2018/0065540 A1
(43) Pub. Date: Mar. 8, 2018

(54) SELECTIVELY DEPLOYABLE VEHICLE BACKUP LIGHT

(71) Applicant: Gary Click, Tuscaloosa, AL (US)

(72) Inventor: Gary Click, Tuscaloosa, AL (US)

(21) Appl. No.: 15/256,434

(22) Filed: Sep. 2, 2016

(51) Int. Cl. B60Q 1/22; B60Q 1/00; B60Q 1/26

(52) U.S. Cl. CPC B60Q 1/22; B60Q 1/2615; B60Q 1/0076

(57) ABSTRACT

A deployable vehicle backup light for providing substantial illumination behind a vehicle. The deployable vehicle backup light includes a light assembly having a housing portion and a lighting portion and a switching assembly that controls the operation of the lighting portion. The housing portion is mountable to the interior of bumper of a host vehicle so as to be obscured from view. The lighting portion is movably attached to the housing portion so as to slide from a base position to a deployed position, in which it is visible, upon receipt of a first signal from the switching assembly and then either automatically or slide back to the base position upon receipt of a second signal from the switching assembly. When in the deployed position, a plurality of lighting elements on the lighting portion energized so as to illuminate.

### BACKGROUND OF THE INVENTION

### Field of the Invention

This invention relates generally to vehicle accessories and, more particularly, to a bumper mounted light housing for a vehicle which is selectively and/or automatically deployable.

### Description of the Prior Art

The use reverse lights on vehicles to warn those nearby of a rearward motion and provide rearward illumination is well known. A problem which still exists, however, is that in many cases, such lights are not particularly effective in providing illumination. Furthermore, many older model vehicles simply do not have such lights. Thus, there remains a need for a vehicle backup light which would selectively deploy from a hidden position when desired. It would be helpful if such a selectively deployable vehicle backup light was positioned to deploy to a centralized location relative to the vehicle or on opposing sides as dual lights (for vehicles with a trailer hitch). It would be additionally desirable for such a selectively deployable vehicle backup light to deploy to a position wherein it provides ground level illumination for the reversing vehicle.

The Applicant's invention described herein provides for a selectively deployable vehicle backup light adapted to selectively provide ground level illumination for a reversing vehicle. The primary components in Applicant's selectively deployable vehicle backup light are a light assembly and a switching assembly. When in operation, the selectively deployable vehicle backup light enables more effective and efficient cleaning lighting of the area behind a reversing vehicle. As a result, many of the limitations imposed by prior art structures are removed.

### SUMMARY OF THE INVENTION

A deployable vehicle backup light for providing substantial illumination behind a vehicle. The deployable vehicle backup light comprises a light assembly having a housing portion and a lighting portion and a switching assembly that controls the operation of the lighting portion. The housing portion is mountable to the interior of bumper of a host vehicle so as to be obscured from view. The lighting portion is movably attached to the housing portion so as to slide from a base position to a deployed position, in which it is visible, upon receipt of a first signal from the switching assembly and then either automatically or slide back to the base position upon receipt of a second signal from the switching assembly. When in the deployed position, a plurality of lighting elements on the lighting portion energized so as to illuminate.

It is an object of this invention to provide a vehicle backup light which would selectively deploy from a hidden position when desired.

It is another object of this invention to provide a selectively deployable vehicle backup light positioned to deploy to a centralized location relative to the vehicle or on opposing sides as dual lights.

It is yet another object of this invention to provide a selectively deployable vehicle backup light which deploys to a position wherein it provides ground level illumination for the reversing vehicle.

These and other objects will be apparent to one of skill in the art.

### BRIEF DESCRIPTION OF THE DRAWINGS

FIG. 1 is a rear elevational view of a vehicle with a selectively deployable vehicle backup light built in accordance with the present invention installed thereon.

FIG. 2A is a front elevational view of a light assembly of a selectively deployable vehicle backup light built in accordance with the present invention.

FIG. 2B is a rear elevational view of a light assembly of a selectively deployable vehicle backup light built in accordance with the present invention

FIG. 3A is a side elevational view of a light assembly of a selectively deployable vehicle backup light built in accordance with the present invention in an base position.

FIG. 3B is a side elevational view of a light assembly of a selectively deployable vehicle backup light built in accordance with the present invention in an deployed position.

FIG. 4 is a block diagram showing a switching assembly in a selectively deployable vehicle backup light built in accordance with an alternate embodiment of the present invention.

### DETAILED DESCRIPTION OF THE INVENTION

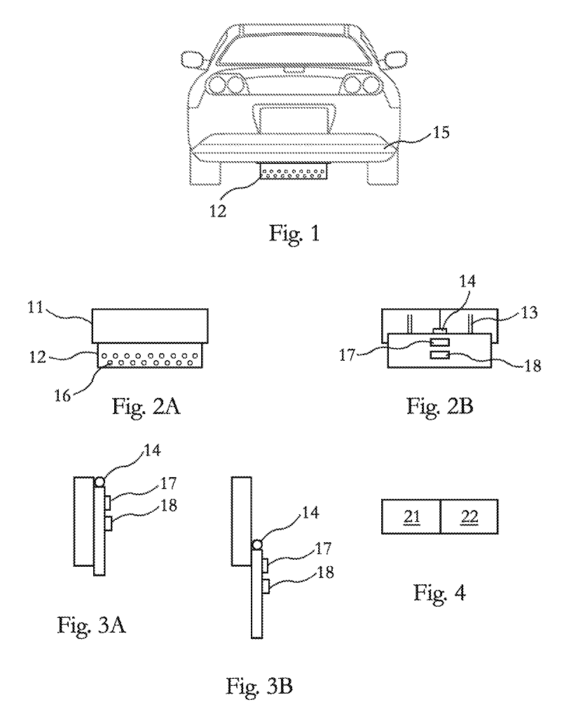

Referring now to the drawings and in particular FIGS. 1, 2A, 2B, 3A, and 3B, a deployable vehicle backup light in one embodiment includes a light assembly 10 and a switching assembly (not shown). The lighting assembly 10 includes a housing portion 11 and a lighting portion 12, with the lighting portion 12 movably attached to the housing portion 11 such that it can slide between a base position and a deployed position. In one embodiment, the lighting portion slides on a pair of tracks 13 on the housing portion 11 and is driven by an electrically driven reel 14. In an alternate embodiment, a gear driven motor or hydraulic cylinder with shaft actuator may be employed in place of the reel 14.

In one embodiment, the housing portion 11 is mountable to the bumper of a host vehicle 15 through a conventional attachment mechanism, such as an adhesive or mechanical fasteners. In this regard, the housing portion 11 is obscured from view from the rear of the vehicle 15.

The lighting portion 12 includes a plurality of lighting elements 16, a control member 17, and a power source 18. The lighting elements 16 are individually positioned in a recess on the front of the lighting portion 12 and are electrically connected to the control member 17. The control member 17, which is additionally connected to the reel 14 and the power source 18, defines in one embodiment a controller operative to selectively direct electrical power from the power source 18 to the lighting elements 16 to cause them to illuminate and the reel 14 to cause the reel 14 to first lower and then raise the lighting portion 12. In this regard, when receiving an activation signal, the control member 17 causes the lighting portion 12 to move from the base position to the deployed position while the lighting elements 16 illuminate. After a predetermined period of time or upon receiving a deactivation signal, the control member 17 ceases the provision of power to the lighting elements and causes the lighting portion 12 to move from the deployed position to the base position.

In one embodiment, the power source 18 is defined by or connected to the battery on the host vehicle.

In one embodiment, the switching assembly defines a toggle switch positioned inside the host vehicle 15 and connected to the control member 17 so as to allow the toggle switch to provide the activation signal and deactivation signal to the control member 17. In this regard, a user in the vehicle 15 can manually cause the lighting portion to move to the deployed position and provide illumination (as well as return to the base position).

It is contemplated that the toggle switch may be connected to the control member 17 through a wire or wirelessly.

Referring now to FIG. 4, in one embodiment, the switching assembly defines a switch 21 integrated with the transmission of the host vehicle and that has an wireless transmitter 22 attached thereto. For example, the switch 21 may define a Neutral Reverse Micro Switch and the wireless transmitter 22 may define a RF transmitter, with an accompanying RF receive integrated with the control member. In such an embodiment, the activation signal is sent automatically when the vehicle 15 is shifted to reverse and the deactivation signal is sent automatically when the vehicle is shifted from reverse.

In an alternate embodiment, the lighting portion slides down from a mountable enclosure.

In an alternate embodiment, the light assembly may be deployed in a pair positioned on opposing sides of a vehicle as dual lights

The instant invention has been shown and described herein in what is considered to be the most practical and preferred embodiment. It is recognized, however, that departures may be made therefrom within the scope of the invention and that obvious modifications will occur to a person skilled in the art.

1. A deployable vehicle backup light for providing illumination behind a host vehicle, comprising:
a light assembly having a housing portion adapted to mount to the host vehicle and a lighting portion movably attached to said housing portion, wherein said lighting portion is configured to move between a base position and a deployed position while remaining on a same axis plane; and
said lighting portion including at least one lighting element operative to illuminate when supplied with electrical power, a power source having stored electrical power, and a control element configured to selectively cause electrical power from the power source to be directed to the at least one lighting element and cause said lighting portion to move from the base position and the deployed position.

2. The deployable vehicle backup light of claim 1, wherein said control element configured to selectively cause electrical power from the power source to be directed to the at least one lighting element and cause said lighting portion to move from the base position and the deployed position upon the receipt of an electrical activation signal.

3. The deployable vehicle backup light of claim 2, wherein said activation signal is generated by manual actuation of a switch.

4. The deployable vehicle backup light of claim 2, wherein said activation signal is generated automatically upon the vehicle being shifted to reverse.

5. The deployable vehicle backup light of claim 2, wherein said control element configured to selectively cease the flow of electrical power from the power source the at least one lighting element and cause said lighting portion to move from the deployed position and the base position upon the receipt of an electrical deactivation signal.

6. The deployable vehicle backup light of claim 2, wherein said control element configured to selectively interrupt the flow of electrical power from the power source the at least one lighting element and cause said lighting portion to move from the deployed position to the base position upon the expiration of a predetermined time period following the activations signal.

7. A deployable vehicle backup light for providing illumination behind a host vehicle, comprising:
a light assembly having a housing portion adapted to mount to the host vehicle and a lighting portion movably attached to said housing portion, wherein said lighting portion is configured to slide between a base position and a deployed position while remaining on a same axis plane; and
said lighting portion including at least one lighting element operative to illuminate when supplied with electrical power, a power source having stored electrical power, and a control element configured to selectively cause electrical power from the power source to be directed to the at least one lighting element and cause said lighting portion to slide from the base position and the deployed position.

8. The deployable vehicle backup light of claim 7, wherein said control element configured to selectively cause electrical power from the power source to be directed to the at least one lighting element and cause said lighting portion to slide from the base position and the deployed position upon the receipt of an electrical activation signal.

9. The deployable vehicle backup light of claim 8, wherein said activation signal is generated by manual actuation of a switch.

10. The deployable vehicle backup light of claim 8, wherein said activation signal is generated automatically upon the vehicle being shifted to reverse.

11. The deployable vehicle backup light of claim 8, wherein said control element configured to selectively cease the flow of electrical power from the power source the at least one lighting element and cause said lighting portion to slide from the deployed position and the base position upon the receipt of an electrical deactivation signal.

12. The deployable vehicle backup light of claim 8, wherein said control element configured to selectively interrupt the flow of electrical power from the power source the at least one lighting element and cause said lighting portion to slide from the deployed position to the base position upon the expiration of a predetermined time period following the activation signal.
